(19) United States
(12) Patent Application Publication
(10) Pub. No.: US 2005/0203262 A1
(43) Pub. Date: Sep. 15, 2005

(54) Fluorinated polymers, photoresists and processes for microlithography

(76) Inventors: Andrew Edward Feiring, Wilmington, DE (US); Frank Leonard Schadt, Wilmington, DE (US); Toshiyuki Ogata, Kanagawa-ken (JP); Koutaro Endo, Kanagawa-ken (JP)

Correspondence Address: E.I. du Pont de Nemours and Company, Legal - Patents, Wilmington, DE, 19898, US

(21) Appl. No.: 10/521,412

(22) PCT Filed: Jul. 23, 2003
(86) PCT No.: PCT/US03/22912

§ 371 Date: Apr. 29, 2005

Related U.S. Application Data
(60) Provisional application No. 60/398,899, filed on Jul. 26, 2002.

(51) Int. Cl. C08F 114/18

(52) U.S. Cl. 526/250; 526/319

(57) ABSTRACT

Fluorinated polymers useful in photoresist compositions and associated processes for microlithography are described. These polymers and photoresists have a fluoroalcohol functional group that simultaneously imparts high ultraviolet (UV) transparency and developability in basic media. The polymers also have a repeat unit derived from a C₁-C₂₅ alkyl hydroxymethylacrylate comonomer, e.g., tert-butyl hydroxymethylacrylate, or a C₅-C₅₀ polycyclic alkyl acrylate in which the polycyclic group contains a hydroxy group, e.g., hydroxyadamantyl acrylate. The materials of this invention have high UV tansparency, particularly at short wavelengths, e.g., 193 nm and 157 nm, which makes them highly useful for lithography at these short wavelengths.

### BACKGROUND OF THE INVENTION

1. Field of the Invention

The present invention pertains to copolymers useful for photoimaging compositions and, in particular, photoresist compositions (positive-working and/or negative-working) for imaging in the production of semiconductor devices. The polymers of the present invention comprise a repeat unit that contains a fluoroalcohol-derived functional group and a repeat unit derived from an alkyl-substituted hydroxymethylacrylate comonomer or a polycycle-substituted acrylate in which the polycyclic group contains a hydroxy substituent. The polymers are especially useful in photoresist compositions having high UV transparency (particularly at short wavelengths, e.g., 157 nm) which are useful as base resins in resists and potentially in many other applications.

2. Description of Related Art

Polymer products are used as components of imaging and photosensitive systems and particularly in photoimaging systems. In such systems, ultraviolet (UV) light or other electromagnetic radiation impinges on a material containing a photoactive component to induce a physical or chemical change in that material. A useful or latent image is thereby produced which can be processed into a useful image for semiconductor device fabrication.

For imaging features at the submicron level in semiconductor devices, electromagnetic radiation in the far or extreme ultraviolet (UV) is needed. Photolithography using 193 nm exposure is a leading candidate for future microelectronics fabrication using 0.18 μm and 0.13 μm design rules; photolithography using 157 nm exposure may be needed for 0.100 μm or less design rules. The opacity of traditional near-UV and far-UV organic photoresists at 193 nm or shorter wavelengths precludes their use in single-layer schemes at 157 nm.

Photoresists comprising copolymers with fluoroalcohol functional groups have been disclosed in WO 00/67072.

Copolymers of fluorinated alcohol monomers with other comonomers have been reported (U.S. Pat. No. 3,444,148 and JP 62186907 A2). These patents are directed to membrane or other non-photosensitive films or fibers, and do not teach the use of fluorinated alcohol comonomers in photosensitive layers (e.g., resists).

There is a critical need for other novel resist compositions that have high transparency at 193 nm, and more preferably at or below 157 nm, and also have other key properties such as good plasma etch resistance and adhesive properties.

### SUMMARY OF THE INVENTION

This invention relates to a fluorine-containing copolymer comprising:
(a) a first repeat unit derived from an ethylenically unsaturated compound containing a functional group having the structure:
   —Xᵣ(CH₂)_{q}C(R_{f})(R_{f}′)OH
   wherein
   R_{f} and R_{f}′ are the same or different C₁-C₁₀ fluoroalkyl groups, or taken together are (CF₂)ₙ;
   n is an integer from 2 to 10;
   X is S, O, N, or P;
   q=0 and r=0, or q=1 and r=0 or 1; and
(b) a second repeat unit derived from an acrylate selected from the group consisting of CH₂═CRCO₂R″ and CH₂═C(CH₂OH)CO₂R′″,
   wherein
   R is H, F, or a C₁-C₅ alkyl or fluoroalkyl group;
   R″ is a polycyclic C₅-C₅₀ alkyl group containing at least one hydroxy group; and
   R′″ is a C₁-C₂₅ alkyl group.

This invention also provides photoresist compositions comprising:
(a) a fluorine-containing copolymer comprising:
   (i) a first repeat unit derived from an ethylenically unsaturated compound containing a functional group having the structure:
      —Xᵣ(CH₂)_{q}C(R_{f})(R_{f}′)OH
   wherein
   R_{f} and R_{f}′ are the same or different C₁-C₁₀ fluoroalkyl groups, or taken together are (CF₂)ₙ;
   n is an integer from 2 to 10;
   X is S, O, N, or P;
   q=0 and r=0, or q=1 and r=0 or 1; and
   (ii) a second repeat unit derived from an acrylate selected from the group consisting of CH₂═CRCO₂R″ and CH₂═C(CH₂OH)CO₂R′″,
   wherein
   R is H, F, or a C₁-C₅ alkyl or fluoroalkyl group;
   R″ is a polycyclic C₅-C₅₀ alkyl group containing at least one hydroxy group; and
   R′″ is a C₁-C₂₅ alkyl group; and
(b) a photoactive component.

This invention also provides a process for preparing a photoresist image on a substrate comprising, in order:
(1) applying a coatable photoresist composition on a substrate, wherein the coatable photoresist composition comprises:
   (a) a fluorine-containing copolymer comprising:
      (i) a first repeat unit derived from an ethylenically unsaturated compound containing a functional group having the structure:
         —Xᵣ(CH₂)_{q}C(R_{f})(R_{f}′)OH
      wherein
      R_{f} and R_{f}′ are the same or different C₁-C₁₀ fluoroalkyl groups, or taken together are (CF₂)ₙ;
      n is an integer from 2 to 10;
      X is S, O, N, or P;
      q=0 and r=0, or q=1 and r=0 or 1; and
      (ii) a second repeat unit derived from an acrylate selected from the group consisting of CH₂═CRCO₂R₁ and CH₂═C(CH₂OH)CO₂R′″,
      wherein
      R is H, F, or a C₁-C₅ alkyl or fluoroalkyl group;
      R″ is a polycyclic C₅-C₅₀ alkyl group containing at least one hydroxy group; and
      R′″ is a C₁-C₂₅ alkyl group; and
   (b) a photoactive component;
   (c) a solvent; and
(2) drying the coatable photoresist composition to substantially remove the solvent to form a photoresist layer on the substrate;
(3) imagewise exposing the photoresist layer to form imaged and non-imaged areas; and
(4) developing the exposed photoresist layer having imaged and non-imaged areas to form a relief image on the substrate.

This invention also provides an article of manufacture comprising:
(a) a substrate; and
(b) a photoresist composition comprising:
   (i) a fluorine-containing copolymer comprising:
      (a′) a first repeat unit derived from an ethylenically unsaturated compound containing a functional group having the structure:
         —Xᵣ(CH₂)_{q}C(R_{f})(R_{f}′)OH
      wherein
      R_{f} and R_{f}′ are the same or different C₁-C₁₀ fluoroalkyl groups, or taken together are (CF₂)ₙ;
      n is an integer from 2 to 10;
      X is S, O, N, or P;
      q=0 and r=0, or q=1 and r=0 or 1; and
      (b′) a second repeat unit derived from an acrylate selected from the group consisting of CH₂═CRCO₂R″ and CH₂═C(CH₂OH)CO₂R′″,
      wherein
      R is H, F, or a C₁-C₅ alkyl or fluoroalkyl group;
      R″ is a polycyclic C₅-C₅₀ alkyl group containing at least one hydroxy group; and
      R′″ is a C₁-C₂₅ alkyl group; and
   (ii) a photoactive component.

### DETAILED DESCRIPTION OF THE INVENTION

Fluorinated Alcohol Copolymers

A fluorine-containing copolymer of this invention comprises a repeat unit derived from at least one ethylenically unsaturated compound containing a functional group derived from a fluoroalcohol or protected fluoroalcohol functional group. This functional group contains fluoroalkyl groups, designated R_{f} and R_{f}′, which can be partially or fully fluorinated alkyl groups. R_{f} and R_{f}′ are the same or different fluoroalkyl groups of from 1 to 10 carbon atoms or taken together are (CF₂)ₙ wherein n is 2 to 10. The phrase “taken together” indicates that R_{f} and R_{f}′ are not separate, discrete fluorinated alkyl groups, but that together they form a ring structure such as is illustrated below in case of a 5-membered ring:

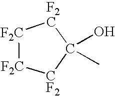

R_{f} and R_{f}′ must be sufficiently fluorinated to impart acidity to the hydroxyl (—OH) of the corresponding fluoroalcohol functional group, such that the hydroxylproton can be substantially removed in basic media (e.g., aqueous sodium hydroxide or tetraalkylammonium hydroxide solution). Preferably, there is sufficient fluorine in the fluoroalcohol functional group such that the hydroxyl group has a pKa value of 5-11. Preferably, R_{f} and R_{f}′ are independently perfluoroalkyl groups of 1 to 5 carbon atoms, most preferably, trifluoromethyl (CF₃). The number of fluoroalcohol groups is determined for a given composition by optimizing the amount needed for good development in aqueous alkaline developer.

More specfically, the fluorine-containing copolymers comprise a repeat unit derived from at least one ethylenically unsaturated compound containing a fluoroalcohol functional group having the structure:
—Xᵣ(CH₂)_{q}C(R_{f})(R_{f}′)OH
wherein R_{f} and R_{f}′ are the same or different fluoroalkyl groups of from 1 to 10 carbon atoms, or taken together are (CF₂)ₙ; n is an integer from 2 to 10; X is selected from the group consisting of S, O, N, and P; q=0 and r=0, or q=1 and r=0 or 1. Preferably, r=0. When r=1, preferably, X is O (oxygen).

Some illustrative, but nonlimiting, examples of representative comonomers containing a fluoroalcohol functional group that are within the scope of the invention are presented below:

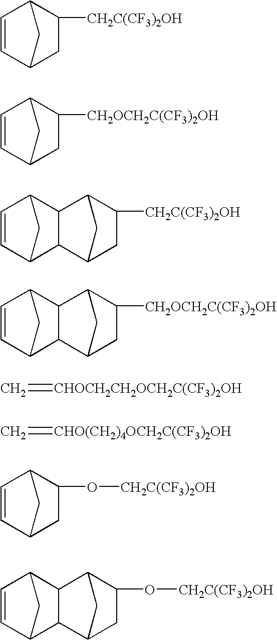

In a preferred embodiment, the fluorinated alcohol is a fluorinated alcohol substituted norbornene, particularly hexafluoroisopropanol substituted norbornene. NB—F—OH is most preferred.

The fluorine-containing copolymer further comprises a repeat unit derived from a hydroxy-substituted acrylate monomer, CH₂═CRCO₂R″ or CH₂═C(CH₂OH)CO₂R′″, wherein R is H, F, an alkyl group of 1 to 5 carbon atoms, or a fluoroalkyl group of 1 to 5 carbon atoms; R″ is a polycyclic C₅-C₅₀ alkyl group containing at least one hydroxy functional group; and R′″ is a C₁-C₂₅ alkyl group.

When the acrylate is CH₂═C(CH₂OH)CO₂R′″, R′″ can be optionally substituted by one or more halogen, ether oxygen, ester or ketone carbonyl groups. Preferably R′″ contains 1 to 20 carbon atoms. A preferred alkyl group, R′″, is one that is acid-labile. Examples of acid-labile alkyl groups include, but are not limited to, tertiary alkyl groups such as tertiary butyl and 2-methyl-2-adamantyl, and α-substituted cyclic ethers such as 2-tetrahydropyranyl and 2-tetrahydrofuranyl. The most preferred repeat unit derived from an alkyl-substituted hydroxymethylacrylate comonomer is tert-butyl hydroxymethylacrylate, CH₂═C(CH₂OH)CO₂^{t}Bu.

When the acrylate group is CH₂═CRCO₂R″, the polycyclic group, R″, contains from 5 to 50 carbon atoms, preferably 5 to 30 carbon atoms, and at least one hydroxyl substituent and is optionally substituted by one or more halogen, ether oxygen, ester or ketone carbonyl groups. A preferred polycyclic acrylate is hydroxyadamantyl acrylate, CH₂═CHCO₂R″, wherein R″ is hydroxyadamantyl. R″ can have one or more fluorine substituents.

The fluorine-containing copolymer can also comprise a repeat unit derived from an ethylenically unsaturated compound (a fluoroolefin) containing at least one fluorine atom attached to an ethylenically unsaturated carbon. This fluoroolefin comprises 2 to 20 carbon atoms. Representative fluoroolefins include, but are not limited to, tetrafluoroethylene, hexafluoropropylene, chlorotrifluoroethylene, vinylidene fluoride, vinyl fluoride, perfluoro-(2,2-dimethyl-1,3-dioxole), perfluoro-(2-methylene-4-methyl-1,3-dioxolane), CF₂═CFO(CF₂)ₜCF═CF₂, where t is 1 or 2, and R_{f}″OCF═CF₂ wherein R_{f}″ is a fluoroalkyl group of from 1 to 10 carbon atoms. A preferred fluoroolefin is tetrafluoroethylene.

The fluorine-containing polymer can also comprise a repeat unit derived from a cyclic or polycyclic unsaturated compound, such as those represented by structures (H) and (I), 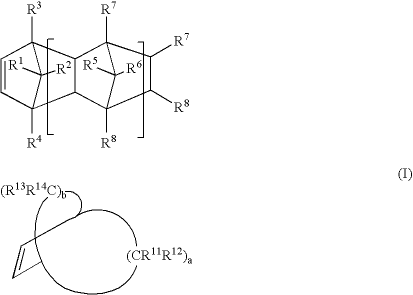
wherein:
n is 0, 1 or 2;
a and b are independently 1, 2 or 3, except that a is not 1 when b is 2 or vice versa; and
R¹ to R⁸ and R¹¹ to R¹⁴ are the same or different and each represents a hydrogen atom, a halogen atom, a carboxyl group, a C₃ to C₁₄ secondary or tertiary alkyl carboxylate, a hydrocarbon group or a substituted hydrocarbon group.

Representative comonomers having structure H include, but are not limited to:

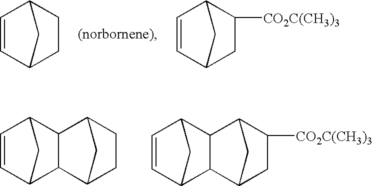

Representative comonomers having structure I include, but are not limited to:

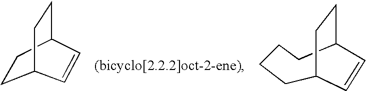

Bifunctional compounds that can initially provide crosslinking and subsequently be cleaved (e.g., upon exposure to strong acid) are also useful as comonomers in the copolymers of this invention. Photoresist compositions, incorporating copolymers comprising these bifunctional monomers, can have improved development and imaging characteristics, since exposure to light photochemically generates strong acid or base, which cleaves the bifunctional group. This results in a very significant drop in molecular weight, which can lead to greatly improved development and imaging characteristics (e.g., improved contrast).

The preferred process for polymerizing the fluorine-containing copolymers of this invention is radical addition polymerization, which was found to avoid the problem of the hydroxy-functionalized acrylate interfering with the polymerization catalyst. Any suitable polymerization initiator, such as di-(4-tert-butylcyclohexyl)peroxy-dicarbonate, can be used under appropriate conditions. The polymerization pressure can range from about 50 to about 10,000 psig, preferably from about 200 to about 1,000 psig. The polymerization temperature can range from about 30° C. to about 120° C., preferably from about 40° C. to about 80° C. Suitable solvents include 1,1,2-trichlorofluoroethane and non-chlorofluorocarbon solvents such as 1,1,1,3,3-pentafluorobutane. The polymerization process is further enhanced by a semi-batch synthesis. In the semibatch synthesis, a part of the monomer mixture is placed in the reaction vessel and then, portionwise or continuously, the remaining monomers and initiator are added to the vessel throughout the polymerization process.

Each fluorine-containing copolymer of this invention has an absorption coefficient of less than 4.0 μm⁻¹ at 157 nm, preferably less than 3.5 μm-1 at 157 nm, more preferably, less than 3.0 μm-1 at 157 nm, and, still more preferably, less than 2.5 μm-1 at 157 nm.

Protective Groups for Removal by PAC Catalvsis

The fluorine-containing copolymers of the resist compositions of this invention can contain one or more components having protected acidic fluorinated alcohol groups (e.g., —C(R_{f})(R_{f}′)ORₐ, where Rₐ is not H) or other acid groups that can yield hydrophilic groups by the reaction with acids or bases generated photolytically from photoactive compounds (PACs). A given protected fluorinated alcohol group contains a protecting group that protects the fluorinated alcohol group from exhibiting its acidity while in this protected form. A given protected acid group (Rₐ) is normally chosen on the basis of its being acid-labile, such that when acid is produced upon imagewise exposure, it will catalyze deprotection of the protected acidic fluorinated alcohol groups and production of hydrophilic acid groups that are necessary for development under aqueous conditions. In addition, the fluorine-containing copolymers will also contain acid functionality that is not protected (e.g., —C(R_{f})(R_{f}′)ORₐ, where Rₐ=H).

An alpha-alkoxyalkyl ether group (i.e., Rₐ=OCH₂R_{b}, R_{b}=C₁-C₁₁ alkyl) is a preferred protecting group for the fluoroalcohol group in order to maintain a high degree of transparency in the photoresist composition. An illustrative, but non-limiting, example of an alpha-alkoxyalkyl ether group that is effective as a protecting group, is methoxy methyl ether (MOM). A protected fluoroalcohol with this particular protecting group can be obtained by reaction of chloromethylmethyl ether with the fluoroalcohol. An especially preferred protected fluoroalcohol group has the structure:
—C(R_{f})(R_{f}′)O—CH₂OCH₂R₁₅
wherein, R_{f} and R_{f}′ are the same or different fluoroalkyl groups of from 1 to 10 carbon atoms or taken together are (CF₂)ₙ wherein n is 2 to 10; R₁₅ is H, a linear alkyl group of 1 to 10 carbon atoms, or a branched alkyl group of 3 to 10 carbon atoms.

Carbonates formed from a fluorinated alcohol and a tertiary aliphatic alcohol can also be used as protected acidic fluorinated alcohol groups.

The fluorine-containing copolymers of this invention can also contain other types of protected acidic groups that yield an acidic group upon exposure to acid. Examples of such types of protected acidic groups include, but are not limited to: A) esters capable of forming, or rearranging to, a tertiary cation; B) esters of lactones; C) acetal esters; D) β-cyclic ketone esters; E) α-cyclic ether esters; and F) esters which are easily hydrolyzable because of anchimeric assistance, such as MEEMA (methoxy ethoxy ethyl methacrylate).

Some specific examples in category A) are t-butyl ester, 2-methyl-2-adamantyl ester, and isobornyl ester.

In this invention, often, but not always, the components having protected groups are repeat units having protected acid groups that have been incorporated in the base copolymer resins of the compositions (as discussed above). Frequently the protected acid groups are present in one or more comonomers that are polymerized to form a given copolymeric base resin of this invention. Alternatively, in this invention, a copolymeric base resin can be formed by copolymerization with an acid-containing comonomer and then subsequently acid functionality in the resulting acid-containing copolymer can be partially or wholly converted by appropriate means to derivatives having protected acid groups.

Photoactive Component (PAC)

The copolymers of this invention can be used to make photoresists by combining the copolymers with at least one photoactive component, a compound that affords either acid or base upon exposure to actinic radiation. If an acid is produced upon exposure to actinic radiation, the PAC is termed a photoacid generator (PAG). If a base is produced upon exposure to actinic radiation, the PAC is termed a photobase generator (PBG). Several suitable photoacid generators are disclosed in WO 00/66575.

Suitable photoacid generators for this invention include, but are not limited to, 1) sulfonium salts (structure I), 2) iodonium salts (structure II), and 3) hydroxamic acid esters, such as structure III.

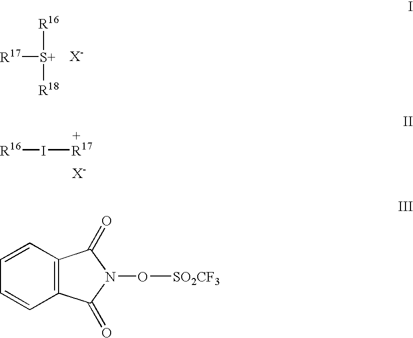

In structures I-II, R₁₆—R₁₈ are independently substituted or unsubstituted aryl or substituted or unsubstituted C₇-C₂₀ alkylaryl (aralkyl). Representative aryl groups include, but are not limited to, phenyl and naphthyl. Suitable substituents include, but are not limited to, hydroxyl (—OH) and C₁-C₂₀ alkyloxy (e.g., —OC₁₀H₂₁). The anion, X⁻, in structures I-II can be, but is not limited to, SbF₆⁻ (hexafluoroantimonate), CF₃SO₃⁻ (trifluoromethylsulfonate=triflate), and C₄F₉SO₃⁻ (perfluorobutylsulfonate).

Dissolution Inhibitors and Additives

Various dissolution inhibitors can be added to photoresists derived from the copolymers of this invention. Ideally, dissolution inhibitors (DIs) for far and extreme UV resists (e.g., 193 nm resists) should be designed/chosen to satisfy multiple materials needs including dissolution inhibition, plasma etch resistance, and adhesion behavior of resist compositions comprising a given DI additive. Some dissolution inhibiting compounds also serve as plasticizers in resist compositions. Several suitable dissolution inhibitors are disclosed in WO 00/66575.

Positive-Working and Negative-Working Photoresists

The photoresists of this invention can either be positive-working photoresists or negative-working photoresists, depending upon choice of components in the fluoropolymer, presence or absence of optional dissolution inhibitor and crosslinking agents, and the choice of developer (solvent used in development). In positive-working photoresists, the resist polymer becomes more soluble and/or dispersible in a solvent used in development in the imaged or irradiated areas whereas in a negative-working photoresist, the resist polymer becomes less soluble and/or dispersible in the imaged or irradiated areas. In one preferred embodiment of this invention, irradiation causes the generation of acid or base by the photoactive component discussed above. The acid or base may catalyze removal of protecting groups from the fluoroalcohol and optionally other acidic groups present in a fluorine-containing polymer comprising a repeat unit derived from at least one ethylenically unsaturated compound containing a fluoroalcohol functional group or a protected fluoroalcohol functional group having the structure:
—C(R_{f})(R_{f}′)ORₐ
wherein R_{f} and R_{f}′ are the same or different fluoroalkyl groups of from 1 to about 10 carbon atoms or taken together are (CF₂)ₙ wherein n is 2 to 10 and Rₐ is hydrogen or a protected functional group. Development in an aqueous base such a tetramethylammonium hydroxide would result in the formation of a positive image whereas development in an organic solvent or critical fluid (having moderate to low polarity), would results in a negative-working system in which exposed areas remain and unexposed areas are removed. Positive-working photoresists are preferred. A variety of different crosslinking agents can be employed as required or optional photoactive component(s) in the negative-working mode of this invention. (A crosslinking agent is required in embodiments that involve insolubilization in developer solution as a result of crosslinking, but is optional in preferred embodiments that involve insolubilization in developer solution as a result of polar groups being formed in exposed areas that are insoluble in organic solvents and critical fluids having moderate/low polarity). Suitable crosslinking agents include, but are not limited to, various bis-azides, such as 4,4′-diazidodiphenyl sulfide and 3,3′-diazidodiphenyl sulfone. Preferably, a negative-working resist composition containing a crosslinking agent(s) also contains suitable functionality (e.g., unsaturated C═C bonds) that can react with the reactive species (e.g., nitrenes) that are generated upon exposure to UV to produce crosslinked polymers that are not soluble, dispersed, or substantially swollen in developer solution, that consequently imparts negative-working characteristics to the composition.
Other Components

Photoresists of this invention can contain additional optional components. Examples of optional components include, but are not limited to, resolution enhancers, adhesion promoters, residue reducers, coating aids, plasticizers, and T_{g} (glass transition temperature) modifiers.

Process Steps

Imagewise Exposure

The photoresist compositions of this invention are sensitive in the ultraviolet region of the electromagnetic spectrum and especially to those wavelengths ≦365 nm. Imagewise exposure of the resist compositions of this invention can be done at many different UV wavelengths including, but not limited to, 365 nm, 248 nm, 193 nm, 157 nm, and lower wavelengths. Imagewise exposure is preferably done with ultraviolet light of 248 nm, 193 nm, 157 nm, or lower wavelengths, preferably it is done with ultraviolet light of 193 nm, 157 nm, or lower wavelengths, and most preferably, it is done with ultraviolet light of 157 nm or lower wavelengths. Imagewise exposure can either be done digitally with a laser or equivalent device or non-digitally with use of a photomask. Digital imaging with a laser is preferred. Suitable laser devices for digital imaging of the compositions of this invention include, but are not limited to, an argon-fluorine excimer laser with UV output at 193 nm, a krypton-fluorine excimer laser with UV output at 248 nm, and a fluorine (F2) laser with output at 157 nm. Since use of UV light of lower wavelength for imagewise exposure corresponds to higher resolution (lower resolution limit), the use of a lower wavelength (e.g., 193 nm or 157 m or lower) is generally preferred over use of a higher wavelength (e.g., 248 nm or higher).

Development

The fluorine-containing copolymers in the resist compositions of this invention must contain sufficient functionality for development following imagewise exposure to UV light. Preferably, the functionality is acid or protected acid such that aqueous development is possible using a basic developer such as sodium hydroxide solution, potassium hydroxide solution, or ammonium hydroxide solution. Some preferred fluorine-containing copolymers in the resist compositions of this invention are acid-containing copolymers or homopolymers comprised of at least one fluoroalcohol-containing monomer of structural unit:
—C(R_{f})(R_{f}′)OH
wherein R_{f} and R_{f}′ are the same or different fluoroalkyl groups of from 1 to 10 carbon atoms or taken together are (CF₂)ₙ wherein n is 2 to 10. The level of acidic fluoroalcohol groups is determined for a given composition by optimizing the amount needed for good development in aqueous alkaline developer.

When an aqueous processable photoresist is coated or otherwise applied to a substrate and imagewise exposed to UV light, development of the photoresist composition may require that the binder material contain sufficient acid groups (e.g., fluoroalcohol groups) and/or protected acid groups that are at least partially deprotected upon exposure to render the photoresist (or other photoimageable coating composition) processable in aqueous alkaline developer. In case of a positive-working photoresist, the photoresist layer will be removed during development in portions which have been exposed to UV radiation but will be substantially unaffected in unexposed portions. Development of positive-working resists typically consists of treatment by aqueous alkaline systems, such as aqueous solutions containing 0.262 N tetramethylammonium hydroxide, at 25° C. for 2 minutes or less. In case of a negative-working photoresist, the photoresist layer will be removed during development in portions which are unexposed to UV radiation, but will be substantially unaffected in exposed portions. Development of a negative-working resist typically consists of treatment with a critical fluid or an organic solvent.

A critical fluid, as used herein, is a substance heated to a temperature near or above its critical temperature and compressed to a pressure near or above its critical pressure. Critical fluids in this invention are at a temperature that is higher than 15° C. below the critical temperature of the fluid and are at a pressure higher than 5 atmospheres below the critical pressure of the fluid. Carbon dioxide can be used for the critical fluid in the present invention. Various organic solvents can also be used as developer in this invention. These include, but are not limited to, halogenated solvents and non-halogenated solvents. Halogenated solvents are preferred and fluorinated solvents are more preferred. A critical fluid can comprise one or more chemical compounds.

Substrate

The substrate employed in this invention can illustratively be silicon, silicon oxide, silicon oxynitride, silicon nitride, or various other materials used in semiconductive manufacture.

### GLOSSARY

Analytical/Measurements

bs broad singlet
δ NMR chemical shift measured in the indicated solvent
g gram
NMR Nuclear Magnetic Resonance
¹H NMR Proton NMR
¹³C NMR Carbon-13 NMR
¹⁹F NMR Fluorine-19 NMR
s singlet
sec. second(s)
m multiplet
mL milliliter(s)
mm millimeter(s)
T_{g} Glass Transition Temperature
Mₙ Number-average molecular weight of a given polymer
M_{w} Weight-average molecular weight of a given polymer
P=M_{w}/Mₙ Polydispersity of a given polymer
Absorption coefficient AC=A/b, where A, absorbance, =Log₁₀(1/T) and b=film thickness in microns, where T=transmittance as defined below.
Transmittance Transmittance, T,=ratio of the radiant power transmitted by a sample to the radiant power incident on the sample and is measured for a specified wavelength λ (e.g., m).
   Chemicals/Monomers
DMF Dimethylformamide
HFIBO Hexafluoroisobutylene epoxide
HAdA Hydroxyadamantyl acrylate
OHKA America, Milpitas, Calif.
MAdA 2-Methyl-2-adamantyl acrylate OHKA America, Inc., Milpitas, Calif.
NBE Norbornene Aldrich Chemical Co., Milwaukee, Wis.
Perkadox® 16 N Di-(4-tert-butylcyclohexyl)peroxydicarbonate Noury Chemical Corp., Burt, N.Y.
Solkane 365 mfc 1,1,1,3,3-Pentafluorobutane Solvay Fluor, Hannover, Germany
t-BuAc tert-Butyl acrylate Aldrich Chemical Company, Milwaukee, Wis.
TBHMA tert-Butyl hydroxymethylacrylate OHKA America, Milpitas, Calif.
TCB Trichlorobenzene Aldrich Chemical Co., Milwaukee, Wis.
TFE Tetrafluoroethylene E. I. du Pont de Nemours and Company, Wilmington, Del.
THF Tetrahydrofuran Aldrich Chemical Co., Milwaukee, Wis.
Vazo®52 2,4-Dimethyl-2,2′-azobis(pentanenitrile) E. I. DuPont de Nemours & Company, Wilmington, Del. 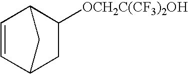
NB-F—OH
   Ultraviolet
Extreme UV Region of the electromagnetic spectrum in the ultraviolet that ranges from 10 nanometers to 200 nanometers
Far UV Region of the electromagnetic spectrum in the ultraviolet that ranges from 200 nanometers to 300 nanometers
UV Ultraviolet region of the electromagnetic spectrum which ranges from 10 nanometers to 390 nanometers
Near UV Region of the electromagnetic spectrum in the ultraviolet that ranges from 300 nanometers to 390 nanometers

### EXAMPLES

Unless otherwise specified, all temperatures are in degrees Celsius, all mass measurements are in grams, and all percentages are weight percentages.

Glass transition temperatures (T_{g}) were determined by DSC (differential scanning calorimetry) using a heating rate of 20° C./min, data is reported from the second heat. The DSC unit used is a Model DSC2910 made by TA Instruments, Wilmington, Del.

Assessment of 157 nm imaging sensitivity is done using a Lambda-Physik Compex 102 excimer laser configured for 157 nm operation. Vacuum ultraviolet transmission measurements are made using a McPherson spectrometer equipped with a D2 light source. Samples are spin-coated at several thicknesses on CaF₂ substrates, and the contribution of the substrate to the transmission is substantially removed by spectral division.

More specifically, all absorption coefficient measurements for polymers can be made using the procedure listed below.

1. Samples are first spin-coated on silicon wafers on a Brewer Cee (Rolla, Mo.), Spincoater/Hotplate model 100CB.
a) Two to four silicon wafers are spun at different speeds (e.g., 2000, 3000, 4000, 6000 rpm) to obtain differing film thickness and the coated wafers are subsequently baked at 120° C. for 30 min. The dried films are then measured for thickness on a Gaertner Scientific (Chicago, Ill.), L116A Ellipsometer (400 to 1200 angstrom range). Two spin speeds are then selected from this data to spin the CaF₂ substrates for the spectrometer measurement.
b) Two CaF₂ substrates (1″ dia.×0.80″ thick) are selected and each is run as a reference data file on a McPherson Spectrometer (Chemsford, Mass.), 234/302 monochrometer, using a 632 Deuterium Source, 658 photomultiplier, and Keithley 485 picoammeter.
c) Two speeds are selected from the silicon wafer data a) to spin the sample material onto the CaF₂ reference substrates (e.g., 2000 and 4000 rpm) to achieve the desired film thickness. Then each is baked at 120° C. for 30 min. and the sample spectra is collected on the McPherson Spectrometer; the sample files are then divided by the reference CaF₂ files.
d) The resulting absorbance files are then adjusted (sample film on CaF₂ divided by CaF₂ blank) for film thickness to give absorbance per micron (abs/mic), which is done using GRAMS386 and KALEIDAGRAPH software.

The term “clearing dose” indicates the minimum exposure energy density (e.g., in units of mJ/cm²) to enable a given photoresist film, following exposure, to undergo development.

### Example 1

### Synthesis of NB—F—OH

A dry round bottom flask equipped with mechanical stirrer, addition funnel and nitrogen inlet was swept with nitrogen and charged with 19.7 g (0.78 mol) of 95% sodium hydride and 500 mL of anhydrous DMF. The stirred mixture was cooled to 5° C. and 80.1 g (0.728 mol) of exo-5-norbornen-2-ol was added dropwise so that the temperature remained below 15° C. The resulting mixture was stirred for 0.5 hr. HFIBO (131 g, 0.728 mol) was added dropwise at room temperature. The resulting mixture was stirred overnight at room temperature. Methanol (40 mL) was added and most of the DMF was removed on a rotary evaporator under reduced pressure. The residue was treated with 200 mL water and glacial acetic acid was added until the pH was about 8.0. The aqueous mixture was extracted with 3×150 mL ether. The combined ether extracts were washed with 3×150 mL water and 150 mL brine, dried over anhydrous sodium sulfate and concentrated on a rotary evaporator to an oil. Kugelrohr distillation at 0.15-0.20 torr and a pot temperature of 30-60° C. gave 190.1 (90%) of product. ¹H NMR (δ, CD₂Cl₂) 1.10-1.30 (m, 1H), 1.50 (d, 1H), 1.55-1.65 (m, 1H), 1.70 (s, 1H), 1.75 (d, 1H), 2.70 (s, 1H), 2.85 (s, 1H), 3.90 (d, 1H), 5.95 (s, 1H), 6.25 (s, 1H) ppm. Another sample prepared in the same fashion was submitted for elemental analysis.

Calcd. for C₁₁H₁₂F₆O₂: C, 45.53; H, 4.17; F, 39.28%. Found: C, 44.98; H, 4.22; F, 38.25%.

### Example 2

### Copolymer of TFE, NB—F—OH and HAdA

A metal pressure vessel of approximate 270 mL capacity was charged with 82.65 g NB—F—OH, 3.33 g HAdA and 25 mL Solkane 365.

The vessel was closed, cooled to about −15° C. and pressured to 400 psi with nitrogen and vented several times. The reactor contents were heated to 50° C. TFE was added to a pressure of 270 psi and a pressure regulator was set to maintain the pressure at 270 psi throughout the polymerization by adding TFE as required. A solution of 84.58 g of NB—F—OH and 27.75 g HAdA diluted to 100 mL with Solkane 365 mfc was pumped into the reactor at a rate of 0.10 mL/minute for 12 hr. Simultaneously with the monomer feed solution, a solution of 9.6 g Perkadox® 16N and 70 mL methyl acetate diluted to 100 mL with Solkane 365 mfc was pumped into the reactor at a rate of 2.0 mL/minute for 6 minutes, and then at a rate of 0.1 mL/minute for 8 hours. After 16 hours reaction time, the vessel was cooled to room temperature and vented to 1 atmosphere. The recovered polymer solution was added slowly to an excess of hexane while stirring. The precipitate was filtered, washed with hexane and air dried. The resulting solid was dissolved in a mixture of THF and Solkane 365 mfc and added slowly to excess hexane. The precipitate was filtered, washed with hexane and dried in a vacuum oven overnight to give 59.8 g of white polymer. From its ¹³C NMR spectrum, the polymer composition was found to be 27% TFE, 48% NB—F—OH and 24% HAdA. DSC: Tg=160° C. GPC: Mn=4900; Mw=8700; Mw/Mn=1.77. Anal. Found: C, 51.95; H, 5.20; F, 27.66%.

### Example 3

### Copolymer of TFE, NB—F—OH and TBHMA

A metal pressure vessel of approximate 270 mL capacity was charged with 71.05 g NB—F—OH, 0.79 g TBHMA and 25 mL Solkane 365. The vessel was closed, cooled to about −15° C. and pressured to 400 psi with nitrogen and vented several times. The reactor contents were heated to 50° C. TFE was added to a pressure of 340 psi and a pressure regulator was set to maintain the pressure at 340 psi throughout the polymerization by adding TFE as required. A solution of 82.57 g of NB—F—OH and 9.88 g TBHMA diluted to 100 mL with Solkane 365 mfc was pumped into the reactor at a rate of 0.10 mL/minute for 12 hr. Simultaneously with the monomer feed solution, a solution of 7.3 g Perkadox® 16N and 60 mL methyl acetate diluted to 100 mL with Solkane 365 mfc was pumped into the reactor at a rate of 2.0 mL/minute for 6 minutes, and then at a rate of 0.1 mL/minute for 8 hours. After 16 hours reaction time, the vessel was cooled to room temperature and vented to 1 atmosphere. The recovered polymer solution was added slowly to an excess of hexane while stirring. The precipitate was filtered, washed with hexane and air dried. The resulting solid was dissolved in a mixture of THF and Solkane 365 mfc and added slowly to excess hexane. The precipitate was filtered, washed with hexane and dried in a vacuum oven overnight to give 28.7 g of white polymer. From its ¹³C NMR spectrum, the polymer composition was found to be 36% TFE, 40% NB—F—OH and 23% TBHMA. DSC: Tg=137° C. GPC: Mn=3100; Mw=4800; Mw/Mn=1.52. Anal. Found: C, 45.33; H, 4.12; F, 36.06%.

### Example 4

### Copolymer of TFE, NB—F—OH, MAdA and HAdA

The procedure of Example 2 was followed except that 80.4 g NB—F—OH, 4.22 g MAdA, 1.07 g HAdA and 25 mL Solkane® 365 were used and a TFE pressure of 280 psi was maintained during the polymerization. A solution of 72.5 g of NB—F—OH, 29.33 g MAdA and 7.4 g HAdA diluted to 100 mL with Solkane 365 mfc was pumped into the reactor at a rate of 0.10 mL/minute for 12 hr. Simultaneously with the monomer feed solution, a solution of 9.6 g Perkadox®16N and 60 mL methyl acetate diluted to 100 mL with Solkane® 365 mfc was pumped into the reactor at a rate of 2.0 mL/minute for 6 minutes, and then at a rate of 0.1 mL/minute for 8 hours. After 16 hours reaction time, the vessel was cooled to room temperature and vented to 1 atmosphere. The recovered polymer solution was added slowly to an excess of heptane while stirring. The precipitate was filtered, washed with heptane and air-dried. The resulting solid was dissolved in a mixture of THF and Solkane® 365 mfc and added slowly to excess heptane. The precipitate was filtered, washed with heptane and dried in a vacuum oven overnight to give 53.9 g of white polymer. From its ¹³C NMR spectrum, the polymer composition was found to be 20% TFE, 38% NB—F—OH, 34% MAdA and 8% HAdA. DSC: Tg=176° C. GPC: Mn=8300; Mw=13400; Mw/Mn=1.62. Anal. Found: C, 55.88; H, 5.52; F, 25.68%.

### Example 5

### Copolymer of TFE NB—F—OH, MAdA and HAdA

A metal pressure vessel of approximate 270 mL capacity was charged with 76.56 g NB—F—OH, 4.75 g MAdA, 3.20 g HAdA, 7.2 g tetrahydrofuran chain transfer agent and 25 mL Solkane® 365. The vessel was closed, cooled to about −15° C. and pressured to 400 psi with nitrogen and vented several times. The reactor contents were heated to 50° C. TFE was added to a pressure of 270 psi and a pressure regulator was set to maintain the pressure at 270 psi throughout the polymerization by adding TFE as required. A solution of 36.54 g of NB—F—OH, 23.10 g MAdA and 15.32 g HAdA diluted to 100 mL with Solkane® 365 mfc was pumped into the reactor at a rate of 0.10 mL/minute for 12 hr. Simultaneously with the monomer feed solution, a solution of 9.96 g Perkadox®16N and 60 mL methyl acetate diluted to 100 mL with Solkane® 365 mfc was pumped into the reactor at a rate of 2.0 mL/minute for 6 minutes, and then at a rate of 0.1 mL/minute for 8 hours. After 16 hours reaction time, the vessel was cooled to room temperature and vented to 1 atmosphere. The recovered polymer solution was added slowly to an excess of hexane while stirring. The precipitate was filtered, washed with hexane and air-dried. The resulting solid was dissolved in a mixture of THF and Solkane® 365 mfc and added slowly to excess hexane. The precipitate was filtered, washed with hexane and dried in a vacuum oven overnight to give 63.4 g of white polymer. From its ¹³C NMR spectrum, the polymer composition was found to be 13% TFE, 39% NB—F—OH, 25% MAdA and 22% HAdA. DSC: Tg=138° C. GPC: Mn=6000; Mw=12900; Mw/Mn=2.15. Anal. Found: C, 57.45; H, 5.95 F, 21.80%.

### Example 6

### Copolymer of TFE, NB—F—OH, MAdA and HAdA

A metal pressure vessel of approximate 270 mL capacity was charged with 76.56 g NB—F—OH, 6.34 g MAdA, 1.60 g HAdA, 7.2 g tetrahydrofuran chain transfer agent and 25 mL Solkane® 365. The vessel was closed, cooled to about −15° C. and pressured to 400 psi with nitrogen and vented several times. The reactor contents were heated to 50° C. TFE was added to a pressure of 270 psi and a pressure regulator was set to maintain the pressure at 270 psi throughout the polymerization by adding TFE as required. A solution of 36.54 g of NB—F—OH, 30.62 g MAdA and 7.73 g HAdA diluted to 100 mL with Solkane® 365 mfc was pumped into the reactor at a rate of 0.10 mL/minute for 12 hr. Simultaneously with the monomer feed solution, a solution of 9.96 g Perkadox®16N and 60 mL methyl acetate diluted to 100 mL with Solkane® 365 mfc was pumped into the reactor at a rate of 2.0 mL/minute for 6 minutes, and then at a rate of 0.1 mL/minute for 8 hours. After 16 hours reaction time, the vessel was cooled to room temperature and vented to 1 atmosphere. The recovered polymer solution was added slowly to an excess of hexane while stirring. The precipitate was filtered, washed with hexane and air-dried. The resulting solid was dissolved in a mixture of THF and Solkane® 365 mfc and added slowly to excess hexane. The precipitate was filtered, washed with hexane and dried in a vacuum oven overnight to give 59.5 g of white polymer. From its ¹³C NMR spectrum, the polymer composition was found to be 13% TFE, 37% NB—F—OH, 38% MAdA and 12% HAdA. DSC: Tg=175° C. GPC: Mn=7200; Mw=13300; Mw/Mn=1.85. Anal. Found: C, 58.94; H, 5.95 F, 21.18%.

### Example 7

### Imaging of Polymer of TFE/NB—F—OH/HAdA

The following solution was prepared and magnetically stirred overnight.

| Component | Wt. (gm) |
|---|---|
| TFE/NB—F—OH/HAdA polymer | 0.684 |
| in Example 2 | |
| 2-Heptanone | 4.788 |
| 6.82% (wt) solution of triphenylsulfonium nonaflate | 0.528 |
| dissolved in 2-heptanone which had been | |
| filtered through a 0.45 μm PTFE syringe filter. | |

Spin coating was done using a Brewer Science Inc. Model-100CB combination spin coater/hotplate on a 4 in. diameter Type “P”, <100> orientation, silicon wafer.

The wafer was prepared by applying a priming layer of hexamethyldisilazane (HMDS) using a YES-3 vapor prime oven (Yield Engineering Systems, San Jose, Calif.). The oven was programmed to give a 5 minute prime at 150-160° C. To prepare the coating, 2 mL of the above solution, after filtering through a 0.45 μm PTFE syringe filter, was deposited on the primed wafer and spun at 2500 rpm for 60 seconds and then baked at 120° C. for 60 seconds.

248 nm imaging was accomplished by exposing the coated wafer to light obtained by passing broadband UV light from an ORIEL Model-82421 Solar Simulator (1000 watt) through a 248 nm interference filter which passes about 30% of the energy at 248 nm. Exposure time was 100 seconds, providing an unattenuated dose of 134 mJ/cm². By using a mask with 18 positions of varying neutral optical density, a wide variety of exposure doses were generated. After exposure the exposed wafer was baked at 120° C. for 60 seconds.

The wafer was tray developed in aqueous tetramethylammonium hydroxide (TMAH) solution (Shipley LDD-26W, 2.38% solution) for 60 seconds, resulting in a positive image with a clearing dose of approximately 38.7 mJ/cm².

### Example 8

### Imaging of Polymer of TFE/NB—F—OH/HAdA

The following solution was prepared and magnetically stirred overnight.

| Component | Wt. (gm) |
|---|---|
| TFE/NB—F—OH/HAdA polymer | 0.576 |
| in Example 2 | |
| 2-Heptanone | 4.788 |
| t-Butyl Lithocholate | 0.108 |
| 6.82% (wt) solution of triphenylsulfonium nonaflate | 0.528 |
| dissolved in 2-heptanone which had been | |
| filtered through a 0.45 μm PTFE syringe filter. | |

A coated wafer was prepared, imaged, and developed as in Example 7. This test generated a positive image with a clearing dose of approximately 14.6 mJ/cm².

### Example 9

### Imaging of Polymer of TFE/NB—F—OHIMAdA/HAdA

A solution was prepared as in Example 7, except that the TFE/NB—F—OH/MAdA/HAdA polymer in Example 5 was used, and magnetically stirred overnight. A coated wafer was prepared, imaged, and developed as in Example 7. This test generated a positive image with a clearing dose of approximately 7.6 mJ/cm².

### Example 10

### Imaging of Polymer of TFE/NB—F—OH/MAdA/HAdA

A solution was prepared as in Example 8, except that the TFE/NB—F—OH/MAdA/HAdA polymer in Example 5 was used, and magnetically stirred overnight. A coated wafer was prepared, imaged, and developed as in Example 7. This test generated a positive image with a clearing dose of approximately 7.6 mJ/cm².

### Example 11

### Imaging of Polymer of TFE/NB—F—OH/MAdA/HAdA

A solution was prepared as in Example 7, except that the TFE/NB—F—OH/MAdA/HAdA polymer in Example 6 was used, and magnetically stirred overnight. A coated wafer was prepared, imaged, and developed as in Example 7. This test generated a positive image with a clearing dose of approximately 7.6 mJ/cm².

### Example 12

### Imaging of Polymer of TFE/NB—F—OH/MAdA/HAdA

A solution was prepared as in Example 8, except that the TFE/NB—F—OH/MAdA/HAdA polymer in Example 6 was used, and magnetically stirred overnight. A coated wafer was prepared, imaged, and developed as in Example 7. This test generated a positive image with a clearing dose of approximately 7.6 mJ/cm².

1. A fluorine-containing copolymer comprising;
(a.) a first repeat unit derived from an ethylenically unsaturated compound containing a functional group having the structure:
—Xᵣ(CH₂)_{q}C(R_{f})(R_{f}′)OH
wherein
R_{f} and R_{f}′ are the same or different C₁-C₁₀ fluoroalkyl groups, or taken together are (CF₂)ₙ;
n is an integer from 2 to 10;
X is S, O, N, or P;
q=0 and r=0, or q=1 and r=0 or 1; and
(b.) a second repeat unit derived from an acrylate selected from the group consisting of CH₂═CRCO₂R″ and CH₂═C(CH₂OH)CO₂R′″,
wherein
R is H, F, or a C₁-C₅ alkyl or fluoroalkyl group;
R″ is a polycyclic C₅-C₅₀ alkyl group containing at least one hydroxy group; and
R′″ is a C₁-C₂₅ alkyl group.

2. The fluorine-containing copolymer of claim 1, wherein (b) is tert-butyl hydroxymethylacrylate.

3. The fluorine-containing copolymer of claim 1, wherein (b) is hydroxyadamantyl acrylate.

4. The fluorine-containing copolymer of claim 3, wherein the polymer further comprises a repeat unit derived from 2-methyl-2-adamantyl acrylate.

5. The fluorine-containing copolymer of claim 4 made by a semi-batch synthesis.

6. The fluorine-containing copolymer of claim 1, further comprising a repeat unit derived from a fluoroolefin selected from the group of ethylenically unsaturated compounds containing at least one fluorine atom covalently attached to an ethylenically unsaturated carbon atom.

7. The fluorine-containing copolymer of claim 6, wherein the fluoroolefin is selected from the group consisting of tetrafluoroethylene, chlorotrifluoroethylene, hexafluoropropylene, trifluoroethylene, and R_{f}OCF═CF₂ wherein R_{f} is a saturated fluoroalkyl group of from 1 to 10 carbon atoms.

8. The fluorine-containing copolymer of claim 1, wherein r=0 and q=0.

9. The fluorine-containing copolymer of claim 1, wherein q=1 and r=0.

10. The fluorine-containing copolymer of claim 1, wherein q=1 and r=1 and X is S, O, N or P.

11. The fluorine-containing copolymer of claim 1, further comprising a repeat unit derived from at least one ethylenically unsaturated compound containing a functional group having the structure
—C(R_{f})(R_{f}′)ORₐ
wherein R_{f} and R_{f}′ are the same or different fluoroalkyl groups of from 1 to 10 carbon atoms or taken together are (CF₂)ₙ wherein n is 2 to 10 and Rₐ is an acid- or base-labile protecting group.

12. The fluorine-containing copolymer of claim 11, wherein Rₐ is CH₂OCH₂R₁₅, and R₁₅ is hydrogen, a linear C₁-C₁₀ alkyl, or a branched C₃-C₁₀ alkyl group.

13. The fluorine-containing copolymer of claim 1, wherein the functional group of repeat unit (a) is —C(CF₃)₂OH.

14. The fluorine-containing copolymer of claim 6, wherein at least one repeat unit is cyclic or polycyclic.

15. The fluorine-containing copolymer of claim 6, further comprising a repeat unit derived from a cyclic or polycyclic unsaturated compound, selected from the group of compounds represented by structures (H) or (I), 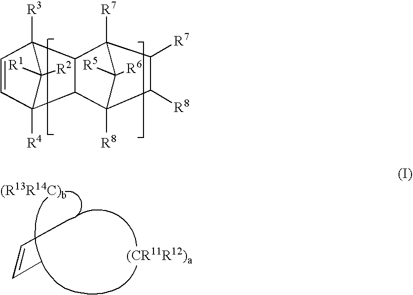
wherein:
n is 0, 1 or 2;
a and b are independently 1, 2 or 3, except that a is not 1 when b is 2 or vice versa; and
R¹ to R⁸ and R¹¹ to R¹⁴ are the same or different, and each represents a hydrogen atom, a halogen atom, a carboxyl group, a C₃ to C₁₄ secondary or tertiary alkyl carboxylate, a hydrocarbon group or a substituted hydrocarbon group.

16. The fluorine-containing copolymer of claim 15, wherein the cyclic or polycyclic unsaturated compound is selected from the group consisting of:

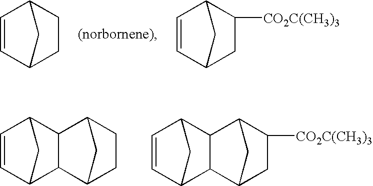

16. The fluorine-containing copolymer of claim 15, wherein the cyclic or polycyclic unsaturated compound is selected from the group consisting of:

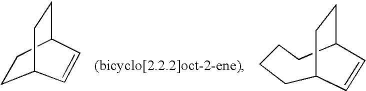

18. The fluorine-containing copolymer of claim 7, wherein the fluoroolefin is tetrafluoroethylene.

19. A photoresist comprising:
(a) a fluorine-containing copolymer comprising:
(i) a first repeat unit derived from an ethylenically unsaturated compound containing a functional group having the structure:
—Xᵣ(CH₂)_{q}C(R_{f})(R_{f}′)OH
wherein
R_{f} and R_{f}′ are the same or different C₁-C₁₀ fluoroalkyl groups, or taken together are (CF₂)ₙ;
n is an integer from 2 to 10;
X is S, O, N, or P;
q=0 and r=0, or q=1 and r=0 or 1; and
(ii) a second repeat unit derived from an acrylate selected from the group consisting of CH₂═CRCO₂R″ and CH₂═C(CH₂OH)CO₂R′″,
wherein
R is H, F, or a C₁-C₅ alkyl or fluoroalkyl group;
R″ is a polycyclic C₅-C₅₀ alkyl group containing at least one hydroxy group; and
R′″ is a C₁-C₂₅ alkyl group; and
(b) at least one photoactive component.

20. The photoresist of claim 19, further comprising a dissolution inhibitor.

21. The photoresist of claim 19, further comprising a solvent.

22. A process for preparing a photoresist image on a substrate comprising, in order:
(1) applying a coatable photoresist composition on a substrate, wherein the coatable photoresist composition comprises:
(a) a fluorine-containing copolymer comprising:
(i) a first repeat unit derived from an ethylenically unsaturated compound containing a functional group having the structure:
—Xᵣ(CH₂)_{q}C(R_{f})(R_{f}′)OH
wherein
R_{f} and R_{f}′ are the same or different C₁-C₁₀ fluoroalkyl groups, or taken together are (CF₂)ₙ;
n is an integer from 2 to 10;
X is S, O, N, or P;
q=0 and r=0, or q=1 and r=0 or 1; and
(ii) a second repeat unit derived from an acrylate selected from the group consisting of CH₂═CRCO₂R″ and CH₂═C(CH₂OH)CO₂R′″,
wherein
R is H, F, or a C₁-C₅ alkyl or fluoroalkyl group;
R″ is a polycyclic C₅-C₅₀ alkyl group containing at least one hydroxy group; and
R′″ is a C₁-C₂₅ alkyl group; and
(b) a photoactive component;
(c) a solvent; and
(2) drying the coatable photoresist composition to substantially remove the solvent to form a photoresist layer on the substrate;
(3) imagewise exposing the photoresist layer to form imaged and non-imaged areas; and
(4) developing the exposed photoresist layer having imaged and non-imaged areas to form a relief image on the substrate.

23. The process of claim 22, wherein R_{f} and R_{f}′ of the fluorine-containing copolymer are CF₃.

24. The process of claim 22, wherein the developing step is performed with an aqueous alkaline developer.

25. The process of claim 22, wherein the developing step is performed with a developer selected from the group consisting of a critical fluid, a halogenated organic solvent, and a non-halogenated organic solvent.

26. The process of claim 25, wherein the critical fluid is carbon dioxide.

27. The process of claim 25, wherein the halogenated solvent is a fluorocarbon compound.

28. An article of manufacture comprising a substrate coated with a photoresist composition of claim 19.
